(19) United States
(12) Patent Application Publication
(10) Pub. No.: US 2014/0237589 A1
(43) Pub. Date: Aug. 21, 2014

(54) Personalization Data of an Active Application

(71) Applicant: Bradley Neal Suggs, Sunnyvale, CA (US)

(72) Inventor: Bradley Neal Suggs, Sunnyvale, CA (US)

(21) Appl. No.: 14/347,347

(22) PCT Filed: Sep. 29, 2011
(86) PCT No.: PCT/US11/54102

§ 371 Date: Mar. 26, 2014

(51) Int. Cl. G06F 21/32

(52) U.S. Cl. CPC G06F 21/32
USPC 726/19

(57) ABSTRACT

A device to detect biometric information of a user, identify the user based on the biometric information, identify an active application of the device and identify metadata of the active application associated with the user, and modify personalization data of the active application with the metadata associated with the user.

### BACKGROUND

As a user is using an application of a device, the user may wish to customize the application to suit the user's preferences. The user can access one or more input components of the device and proceed to access settings associated with the application. The user can continue to modify the settings until the user is satisfied with the settings. Once the user exits the application, the application can undo or delete the modifications from the user and load default settings. If the user would like to use the application again, the user can repeat this process each time which may be tedious and time consuming for the user.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device accessing an application according to an example.

FIG. 2 illustrates a sensor detecting biometric information of a user according to an example.

FIG. 3 illustrates a block diagram of a profile application identifying a user and identifying metadata associated with the user according to an example.

FIG. 4 illustrates a block diagram of a profile application modifying personalization data of an active application according to an example.

FIG. 5 is a flow chart illustrating a method for managing an application according to an example.

FIG. 6 is a flow chart illustrating a method for managing an application according to another example.

### DETAILED DESCRIPTION

A sensor, such as an image capture component and/or a microphone can detect biometric information of a user if the user is within proximity of the device. The biometric information can be an image of the user's face, a fingerprint of the user, and/or a voice of the user. The device can also identify an active application of the device and identify metadata of the active application associated with the user. For the purposes of this application, an active application is a software application of the device which can be executed by the device and/or the user. The active application can be a web browser, an instant messenger, a video conference application, a text editor, an email application, a media player, a media editor, and/or any additional software application.

The metadata includes information and/or data which the active application can use to modify personalization data of the active application. The personalization data includes one or more files associated with the active application that if modified with metadata can configure a setting, use, and/or an interface of the active application. In one embodiment, the metadata includes settings which the user prefers to use with the active application. In another embodiment, the metadata includes bookmarks or favorite links for the user. In other embodiments, the metadata includes themes or customizations of the user which modify an interface of the active application.

By detecting biometric information of a user, the user can securely be identified with the biometric information. As a result, time can be saved by not logging another user of the device out of the device to identify metadata of an active application associated with the identified user. Additionally, by modifying personalization data of an active application with the metadata, the active application can be tailored for the identified user and a seamless and user friendly experience can be created for the identified user.

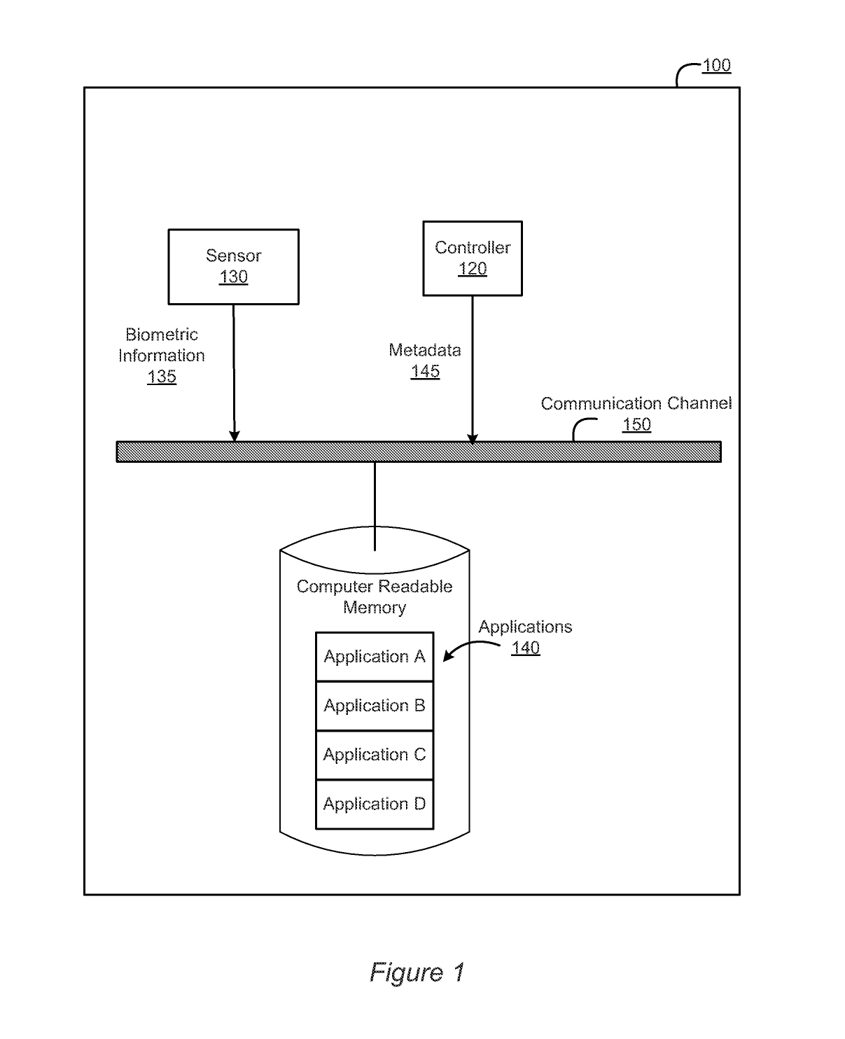

FIG. 1 illustrates a device 100 accessing an application 140 according to an example. In one embodiment, the device 100 is a laptop, a notebook, a tablet, a netbook, an all-in-one system, and/or desktop. In another embodiment, the device 100 can be a cellular device, a PDA (Personal Digital Assistant), an E (Electronic)-Reader, and/or any additional computing device with one or more applications 140. As shown in FIG. 1, the device 100 includes a controller 120, a sensor 130, a computer readable memory with one or more applications 140, and a communication channel 150 for the components of the device 100 to communicate with one another.

In one embodiment, the device 100 additionally includes a profile application which can be utilized independently and/or in conjunction with the controller 120 to manage an application 140 of the device 100. The profile application can be a software application and/or firmware embedded onto the device 100. In another embodiment, the profile application can be stored and accessed from the computer readable memory. The computer readable memory can include non-transitory memory of the device 100. In other embodiments, the device 100 can include other components in addition to and/or in lieu of those noted above and illustrated in FIG. 1.

When managing an application 140, the controller 120 and/or the profile application use a sensor 130 of the device 100 to detect biometric information 135 of a user. The user can be any person which can access and/or use the device 100. For the purposes of this application, the sensor 130 is a hardware component of the device 100 which can detect biometric information 135 of the user if the user is within proximity of the device 100. In one embodiment, the sensor 130 includes an image capture component and/or a microphone to detect the biometric information 135 from the user. The sensor 130 can detect if the user is within proximity by detecting for any motion, capturing an image or video, and/or by detecting audio around the device 100.

When detecting biometric information 135 from the user, the sensor 130 can capture an image of the user's face, an image of the user's retinas, an image of a fingerprint of the user, and/or a voice of the user. The biometric information 135 can be used by the controller 120 and/or the profile application to identify the user. In one embodiment, the controller 120 and/or the profile application can access a list or database of recognized users to compare the detected biometric information 135 to predefined information corresponding to recognized users of the device 100. If a match is found, the user will be determined to be identified.

In response to identifying the user, the controller 120 and/or the profile application can identify an active application of the device 100. In another embodiment, the controller 120 and/or the profile application can identify an active application in parallel with identifying the user. For the purposes of this application, an active application is a software application 140 of the device 100 which can be executed by the controller 120, the profile application, and/or the user. One or more applications 140 can be stored on a computer readable memory of the device 100. In another embodiment, one or more of the applications 140 can be stored on another device accessible to the controller 120 and/or the profile application.

When identifying an active application, the controller 120 and/or profile application can identify one or more applications 140 which are currently active. An application 140 is active if the application 140 is currently running or executed on an operating system of the device 100. The controller 120 and/or the profile application can poll the operating system for a list of applications which are currently running or executed to identify any active applications. In another embodiment, the controller 120 and/or the profile application can detect for the identified user launching an application 140 when identifying an active application of the device 100.

In response to identifying an active application, the controller 120 and/or the profile application can identify metadata 145 of the active application associated with the user. For the purposes of this application, metadata 145 includes information and/or data associated with the user which can list settings, interfaces, and/or files to be used with an application. In one embodiment, the metadata 145 is a file which includes the settings, interfaces, and/or files which the user prefers to use with the active application.

When identifying the metadata 145, the controller 120 and/or the profile application can search for metadata of the active application and determine if any of them are listed to be associated with the user. If a match is found, the metadata 145 of the active application associated with the user will have been identified. In another embodiment, the controller 120 and/or the profile application can determine if the list of recognized users list metadata 145 associated with the identified user.

In one embodiment, if no match is found, the controller 120 and/or the profile application creates new metadata of the active application and associates it with the user. Any information which the user uses for the active application and/or any modifications the user makes for the active application can be stored as new metadata of the active application associated with the user.

The controller 120 and/or the profile application use the metadata 145 to modify personalization data of the active application. For the purposes of this application, personalization data includes one or more files associated with the active application that if modified with metadata 145 can modify a setting, use, and/or an interface of the active application for the user. In one embodiment, the controller 120 and/or the profile application modify the personalization data of the active application with the metadata 145 while another user of the device 100 is logged into the operating system of the device 100. As a result, the other user is not logged off of the device 100 by the operating system as the active application is tailored for the user with the metadata 145 associated with the user.

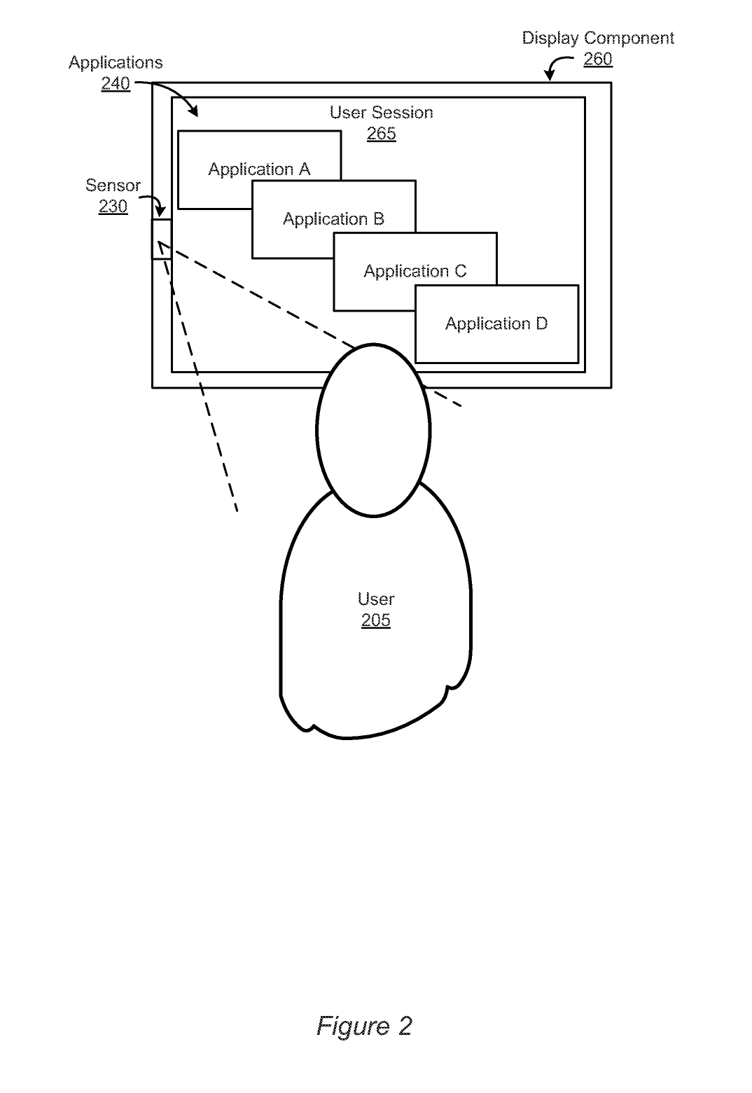

FIG. 2 illustrates a sensor 230 detecting biometric information of a user 205 according to an example. As noted above, the user 205 can be any person which can access the device. The sensor 230 is a hardware component of the device which can detect if the user 205 is within proximity of the device and detect biometric information from the user 205. In one embodiment, the sensor 230 includes an image capture component to capture a view, an image, and/or a video stream of a face, retina, palm and/or fingerprint of the user 205. In another embodiment, the sensor 230 includes a microphone to capture a voice of the user 205. In other embodiments, the sensor 230 can be any additional hardware component of the device to detect biometric information from the user 205. The sensor 230 can be integrated as part of the device. In another embodiment, as illustrated in FIG. 2, the sensor 230 can be coupled to a component of the device, such as a display component 260 of the device.

When detecting if the user 205 is within proximity of the device, the sensor 230 can detect for motion, capture an image, and/or detect for audio to determine if the user 205 is within proximity of the device. If the user 205 is within proximity of the device, the sensor 230 can proceed to detect biometric information from the user 205. When detecting biometric information, the sensor 230 can capture a view, image, and/or video stream of the user's 205 face, the user's 205 retina, the user's 205 fingerprint, and/or the user's palm. In another embodiment, the sensor 230 can capture a voice of the user 205. Using the detected biometric information of the user 205, a controller and/or profile application of the device can identify the user with the biometric information.

As the user is being identified with the biometric information, the controller and/or the profile application can identify one or more applications 240 which are active of the device. As noted above, an active application is a software application 240 of the device which is running or is executed on the device. An application 240 can be a web browser, an instant messenger, a video conference application, a text editor, an email application, a media player, a media editor, and/or any additional software application which can be launched or executed for use on a user session 265 the device. An application can be launched or executed on a user session 265 by the controller, the profile application, and/or by the user 205 of the device.

For the purposes of this application, a user session 265 includes a session of an operating system corresponding to the user or another user of the device. The operating system can initiate the user session 265 in response to the user 205 or another user logging into the operating system and/or the device. As shown in FIG. 2, the user session 265 can be displayed on a display component 260 of the device. The display component 260 is a hardware output component which can display the user session 265. In one embodiment, the display component 260 is a LCD (liquid crystal display), a LED (light emitting diode) display, a CRT (cathode ray tube) display, a plasma display, a projector and/or any additional device configured to display the user session 265.

The controller and/or the profile application can identify which of the applications 240 are active in the user session 265. In one embodiment, the controller and/or the profile application can poll the operating system for a list of applications 240 which are currently launched or executed for use in the user session 265. In another embodiment, the sensor 230 can detect for the user accessing one or more of the applications 240 through a visual, audio, and/or touch gestures. In other embodiments, the device can additionally include an input component for the user to use when accessing one or more applications 240. The input component can be a mouse, a keyboard, a touch screen, and/or any additional component which can detect the user 205 accessing an application 240 of the device. In response to identifying one or more active applications, the controller and/or the profile application can identify metadata of the active application associated with the user 205.

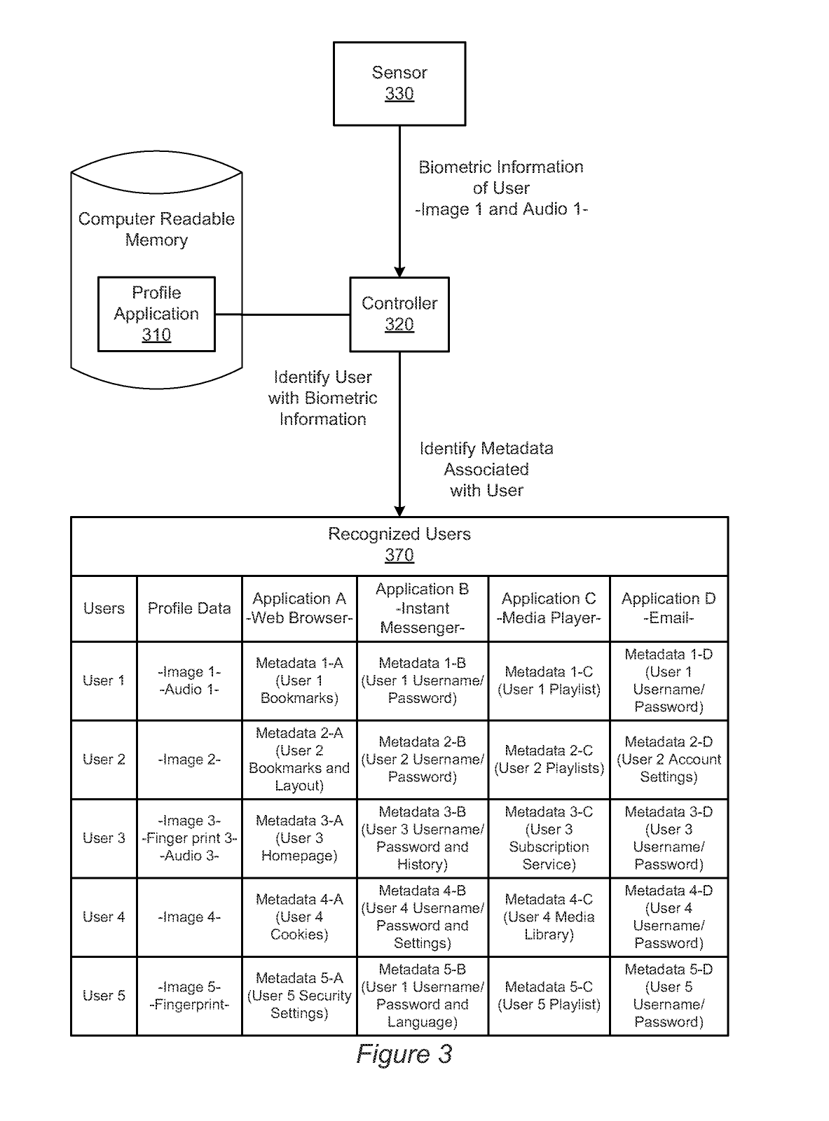

FIG. 3 illustrates a block diagram of a profile application 310 identifying a user and identifying metadata associated with the user according to an example. As illustrated in FIG. 3, the profile application 310 can be stored on a non-transitory removable medium being accessed by the device according to an embodiment. In one embodiment, the profile application 310 is firmware that is embedded into one or more components of the device as ROM. In other embodiments, the profile application 310 is an application which is stored and accessed from a hard drive, a compact disc, a flash disk, a network drive or any other form of computer readable medium that is coupled to the device.

The controller 320 and/or the profile application 310 receive biometric information from the sensor 330 and attempt to identify the user with the biometric information. As shown in the present embodiment, the sensor 330 has captured Image 1 and Audio 1 from the user. The controller 320 and/or the profile application 310 proceed to access a list of recognized users 370 to identify the user. The list of recognized users 370 can include entries for one or more users of the device recognized by the controller 320 and/or the profile application 310. Additionally, each entry includes biometric information of the corresponding recognized user.

When identifying the user, the controller 320 and/or the profile application 310 compared the detected biometric information of Image 1 and Audio 1 to each of the entries in the list of recognized users 370. If a match is found, the user will be determined to be recognized and will thus be identified. In the present embodiment, the controller 320 and/or the profile application 310 determine that the first entry corresponding to User 1 includes the biometric information of Image 1 and Audio 1. As a result, the user is identified by the controller 320 and/or the profile application 310 to be User 1. In another embodiment, the user can additionally be prompted to enter a security code, token, and/or key when identifying the user. In other embodiments, the controller 320 and/or the profile application 310 can use additional methods to identify the user with biometric information in addition to and/or in lieu of those noted above.

Once the user has been identified, the controller 320 and/or the profile application 310 identify metadata of an active application associated with the identified user. As illustrated in FIG. 3, the entries in the list of recognized users 370 lists metadata for one or more applications of the device associated with each recognized user. As a result, when identifying metadata for an active application, the controller 320 and/or the profile application 310 access the entry corresponding to the identified user to identify metadata associated with the identified user for one or more applications. As shown in the present embodiment, the controller 320 and/or the profile application 310 identify that Metadata 1-A is associated with User 1 and can be used for Application A, Metadata 1-B is associated User 1 and can be used for Application B, Metadata 1-C is associated with User 1 and can be used for Application C, and Metadata 1-D is associated with User 1 and can be used for Application D.

In other embodiments, if the controller 320 and/or the profile application 310 were previously not able to identify the user, the controller 320 and/or the profile application 310 can create a new recognized user for the device. Additionally, the list of recognized users 370 can be updated to include the new user, biometric information of the new user, and metadata of the new user. The user is not identified if the detected biometric information does not match any of the recognized users in the list of recognized users 370.

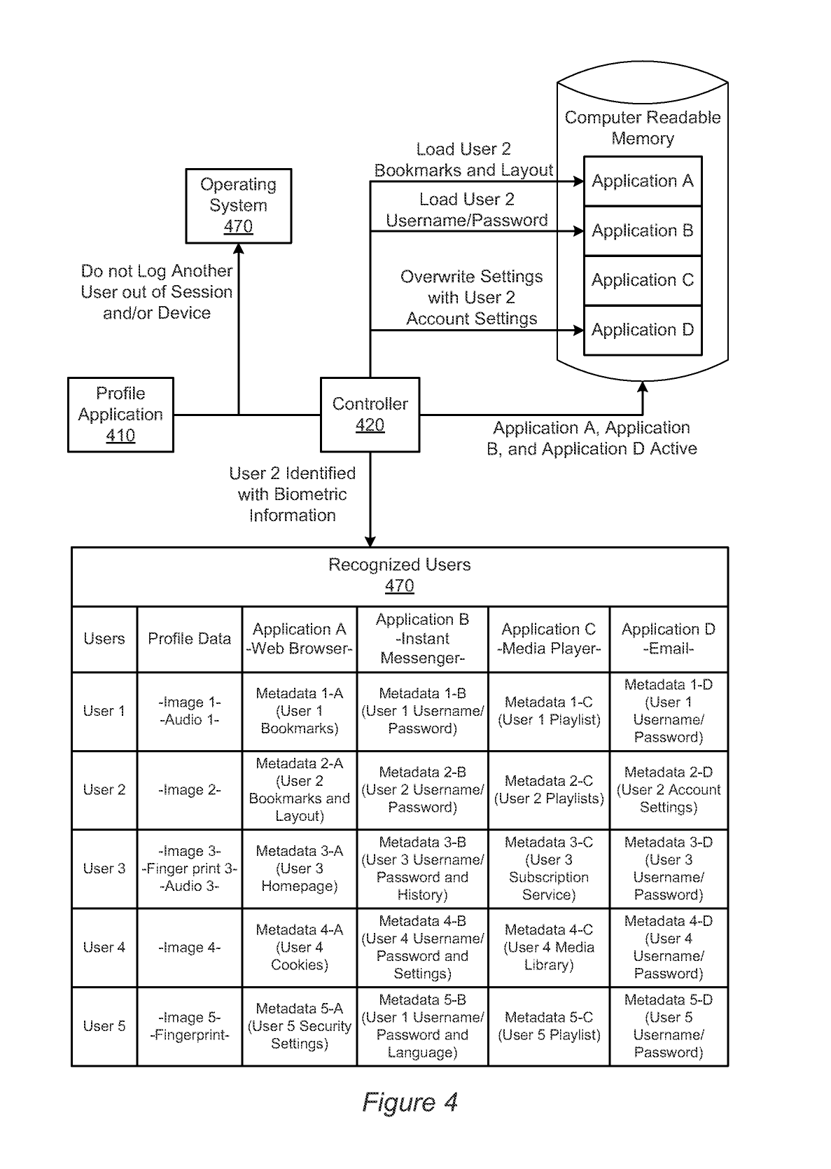

FIG. 4 illustrates a block diagram of a profile application 410 modifying personalization data of the active application according to an example. As illustrated in the present embodiment, the controller 420 and/or the interface application 410 have identified User 2 with the detected biometric information. In response to the User 2 being identified, the controller 420 and/or the interface application 410 proceed to identify one or more active applications of the device. In another embodiment, the controller 420 and/or the interface application identify one or more active applications while in parallel detecting biometric information from a user and identifying the user.

As noted above, the controller 420 and/or the profile application 410 can poll an operating system 470 for a list of applications which are currently launched or executed for use in a user session of the operating session 470. In another embodiment, the controller 420 and/or the profile application detect for User 2 accessing or launching one or more of applications through a visual, audio, and/or touch gestures. In other embodiments, the controller 420 and/or the interface application 410 can access a history corresponding to User 2 to determine which application User 2 previously accessed. One or more of the previously accessed application can be identified by the controller 420 and/or the interface application 410 to be an active application.

As shown in the present embodiment, the controller 420 and/or the profile application 410 have identified Application A—Web Browser, Application B—Instant Messenger, and Application D—Email Application to be active applications. In response, the controller 420 and/or the interface application 410 access metadata of the active application associated with User 2. As shown in FIG. 4, the controller 420 and/or the profile application 410 access the list of recognized users 470 and determine that Metadata 2-A is associated is associated with User 2 and is used for Application A—Web Browser.

The controller 420 and/or the profile application 410 access the contents of Metadata 2-A and determine that it includes Bookmarks of User 2 to be used for Application A. Additionally, Metadata 2-A lists for Application A to use a layout corresponding to User 2. In response, the controller 420 and/or the interface application 410 access the personalization data of Application A and proceeds to modifying the personalization based on Metadata 2-A. In one embodiment, modifying the personalization data includes overwriting contents of the personalization data with the contents of Metadata 2-A. In another embodiment, the controller 420 and/or the interface application 410 modify one or more settings or parameters of the personalization data with the contents of Metadata 2-A. By modifying the personalization data of Application A with the contents of Metadata 2-A, Application A accesses the personalization data and includes User 2's Bookmarks and uses User 2's layout with Application A.

Additionally, the controller 420 and/or the interface application 410 determine that Metadata 2-B is associated User 2 and is used with Application B. Further, Metadata 2-B is determined to include a username and password for User 2. In response, the controller 420 and/or the interface application 410 modify the personalization data of Application B by overwriting the personalization data to include the username and password for User 2. As a result, Application B loads the username and password for User 2 to log User 2 into the instant messenger.

Further, the controller 420 and/or the interface application 410 determine that Metadata 2-D is associated User 2 and is used with Application D. Further, Metadata 2-D is determined to include account settings for User 2. The account settings can include a username and password for an email account of User 2. The controller 420 and/or the interface application 410 modify the personalization data of Application C to include the email account settings of User. As a result, Application D overwrites default email account settings with the email account settings of User 2. As noted above, when modifying the personalization data of an application with metadata associated with a user, the user or another user of the device are not logged out of a current user session of the operating system 470. In one embodiment, the controller 420 and/or the profile application 410 can issue an instruction for the operating system 470 to not log another user out of the operating system 470 or the device.

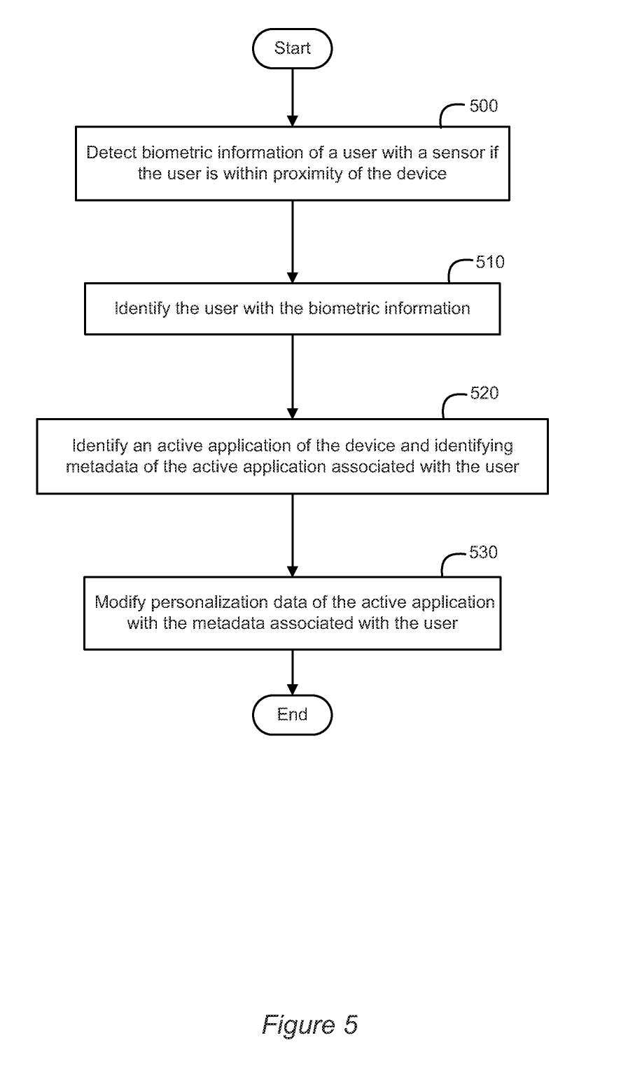

FIG. 5 is a flow chart illustrating a method for managing an application according to an example. The controller and/or the profile application can be utilized independently and/or in conjunction with one another to manage an application. A sensor, such as an image capture component and/or a microphone can detect biometric information from a user if the user is within proximity of the device at 500. The sensor can capture an image, a video, and/or a voice from the user when detecting biometric information from the user.

The biometric information can be shared with the controller and/or the interface application to identify the user at 510. In one embodiment, the controller and/or the interface application access a list of recognized users and compare the detected biometric information to predefined biometric information of recognized users of the device. If the detected biometric information matches any of the recognized users, the user will be identified.

In response to identifying the user, the controller and/or the interface application can identify one or more active applications of the device and identify metadata of the active application associated with the identified user at 520. In another embodiment, the controller and/or the profile application identify one or more active applications in parallel with detecting biometric information and/or in parallel with identifying the user. As noted above, an active application can be any application which is currently executed and/or launched on a current user session. In another embodiment, the controller and/or the interface application can identify an application to be active in response to a user launching the application and/or based on a history of active applications of the user.

When identifying metadata of an active application associated with the identified user, the controller and/or the profile application can access the list of recognized users to determine if the corresponding entry of the identified user lists metadata of the user for use on an application. If any metadata associated with the identified user is listed for use for an active application, the metadata will be identified. The controller and/or the profile use the metadata associated with the user to modify personalization data of an active application at 530.

As noted above, the personalization data includes data and/or information that if modified can change a setting, an interface, and/or a use of the corresponding application. By modifying the personalization data with the metadata, the active application can be seamlessly be tailored and customized to suit the identified user's preferences. The method is then complete. In other embodiments, the method of FIG. 5 includes additional steps in addition to and/or in lieu of those depicted in FIG. 5.

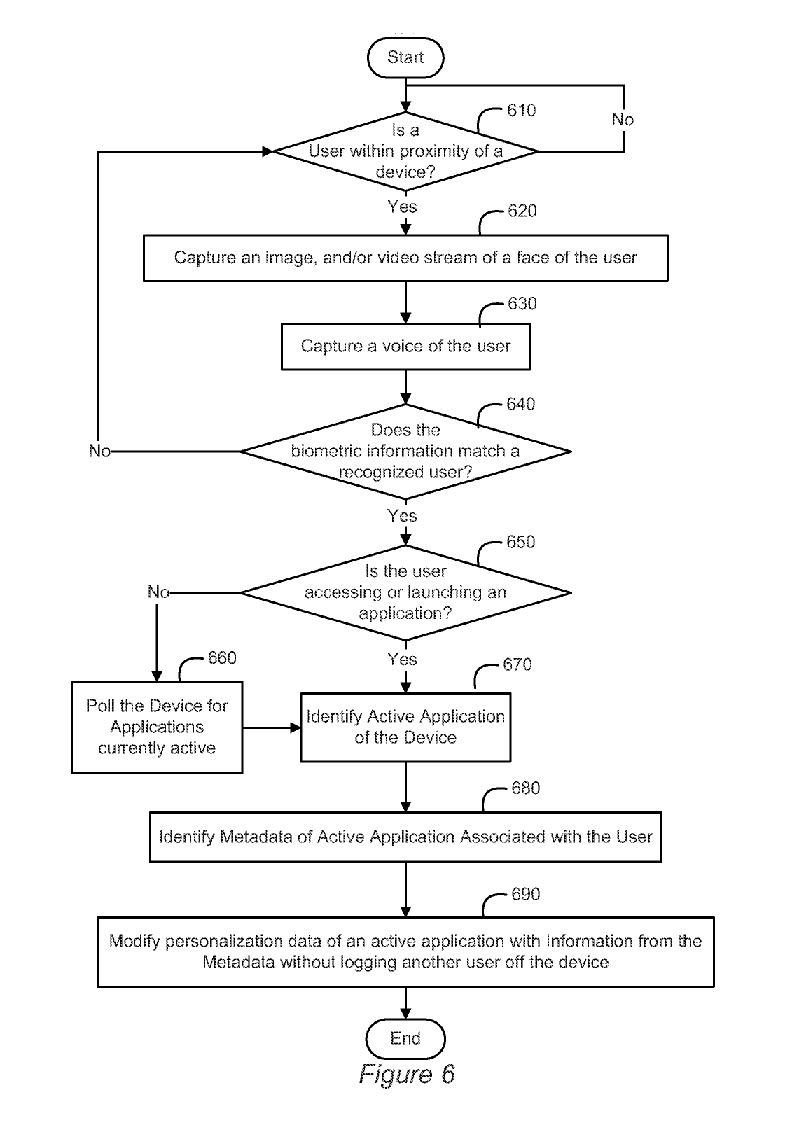

FIG. 6 is a flow chart illustrating a method for managing an application according to another example. A sensor of the device detects for a user being within proximity of the device at 610. The sensor can capture an image, detect for motion, and/or detect for audio to determine if the user is within proximity. If no user is detected, the sensor can continue to detect for a user at 610. If a user is detected, the sensor detects biometric information of the user by capturing an image and/or video stream of the user's face, retina, palm, and/or finger at 620. The sensor can additionally capture a voice of the user at 630.

The controller and/or the profile application can then attempt to identify the user by determining if the detected biometric information matches any recognized user of the device at 640. The controller and/or the interface application compare the biometric information to entries in a list of recognized users and scan for a match. If a match is found, the user will be identified to be the corresponding recognized user. If no match is found, the sensor continues to detect for a user within proximity of the device at 610.

If the user is identified, the controller and/or the profile application determine if the user is accessing or launching any application of the device at 650. If the user is detected to launch or access any application, the application is identified to be an active application at 670. In another embodiment, if the user is not accessing or launching an application, the controller and/or the interface application can poll the device and/or an operating system for a list of applications which are currently executed on the device at 660. Each of the executed applications can be identified as an active application at 670.

The controller and/or the interface application then identify metadata of the active application associated with the identified user at 680. The controller and/or the profile application can access the list of recognized users to determine if an entry corresponding to the identified user lists metadata associated with the user to be used for an application. If any metadata associated with the user can be used for one or more of the active application, the metadata will be identified. The controller and/or the profile application can then modify personalization data of the active application with information from the metadata of the user at 690.

As noted above, modifying the personalization data can include overwriting a file, a setting, and/or a parameter of the personalization data. In one embodiment, the personalization data is modified without logging the user or another user out of a user session of the operating system. As a result, an active application can seamlessly be customized and/or tailored for a user regardless of whether the user is currently logged into the device or a user session of the device. In other embodiments, the method of FIG. 6 includes additional steps in addition to and/or in lieu of those depicted in FIG. 6.

What is claimed is:

1. A method for managing an application comprising:
detecting biometric information of a user with a sensor if the user is within proximity of a device;
identifying the user with the biometric information;
identifying an active application of the device and identifying metadata of the active application associated with the user; and
modifying personalization data of the active application with the metadata associated with the user.

2. The method for managing an application of claim 1 wherein modifying personalization data of the active application with the metadata does not include logging another user out of the device.

3. The method for managing an application of claim 1 wherein detecting biometric information of the user includes capturing at least one of an image and a video stream of a face of the user.

4. The method for managing an application of claim 1 wherein detecting biometric information of the user includes detecting a voice of the user.

5. The method for managing an application of claim 1 wherein identifying an active application includes detecting a user accessing at least one application of the device.

6. The method for managing an application of claim 1 wherein identifying an active application includes polling the device for a list of active applications.

7. A device comprising:
a sensor to detect biometric information of a user if the user is within proximity of the device; and
a controller to:
identify the user based on the biometric information;
identify an active application of the device and identify metadata of the active application associated with the user;
modify personalization data of the active application with the metadata associated with the user.

8. The device of claim 7 wherein the sensor includes an image capture component to capture at least one of a view, an image, and a video stream of a face or fingerprint of the user.

9. The device of claim 7 wherein the sensor includes a microphone to detect a voice of the user.

10. The device of claim 7 further comprising an input component to detect a user accessing an application of the device for the controller to identify the active application.

11. The device of claim 7 further comprising an operating system to not log the other user off of the device when the controller modifies personalization data of the active application with the metadata of the active application associated with the user.

12. A computer readable medium comprising instructions that if executed cause a controller to:
identify a user in response to a sensor detecting biometric information of the user within proximity of a device;
identify an active application of the device and identify metadata of the active application associated with the user; and
modify personalization data of the active application with the metadata of associated with the user without logging another user out of the device.

13. The computer readable medium of claim 12 wherein the controller compares detected biometric information of the user to a list of recognized users to identify the user.

14. The computer readable medium of claim 13 wherein the list of recognized users lists metadata of applications associated with each recognized user.

15. The computer readable medium of claim 12 wherein the controller overwrites at least one of a setting of the active application and a parameter of the active application with information included in the metadata associated with the user to modify the active application.
